(19) United States
(12) Patent Application Publication
(10) Pub. No.: US 2004/0245049 A1
(43) Pub. Date: Dec. 9, 2004

(54) Method and device for the lubrication by atomization of lubricating points with minimal quanities of lubricant

(76) Inventor: Franz Vullhorst, Hovelhof (DE)

Correspondence Address: BIRCH STEWART KOLASCH & BIRCH, PO BOX 747, FALLS CHURCH, VA, 22040-0747, US

(21) Appl. No.: 10/486,881

(22) PCT Filed: Aug. 13, 2002
(86) PCT No.: PCT/DE02/02984

(30) Foreign Application Priority Data
Aug. 17, 2001 (DE) 101393474

(51) Int. Cl. F16N 1/00

(52) U.S. Cl. 184/5

(57) ABSTRACT

The invention relates to a method for the lubrication of lubricating points with minimal quantities of lubricant. According to said method, the lubricant is mixed with a gaseous carrier medium to form a lubricant mist. Said lubricant mist is led to the lubricating point. In order to separate lubricant drops, the lubricant mist is injected at high speed in an elongated chamber having distributed separation surfaces, which are perforated in the longitudinal direction of the chamber. The lubricant moves through the chamber towards a discharge opening, with the continuous moistening of the separation surfaces, and leaves the discharge opening in the form of lubricant drops.

The invention relates to a method for the lubrication of lubrication points with minimal quantities of lubricant, in which the lubricant is mixed with a gaseous carrier medium to form a lubricant mist and in which the lubricant mist is supplied to the lubrication point.

Furthermore, the invention relates to a device for the lubrication of lubrication points with minimal quantities of lubricant with an atomizer to produce a lubricant mist, which is formed from a mixture of a gaseous carrier medium and microdrops of the lubricant.

DE 40 02 846 C2 discloses a method for the lubrication and cooling of cutting tools with minimal quantities of lubricant, in which the lubricant drops are fed into a chamber provided with sphere packing, so that an atomization effect is achieved by means of an entraining air blast. The lubricant drop size achieved hereby is within the range of >10 μm. In fact, the prior-art method or the prior-art device enables a relatively simple lubricant dosing, because the droplet size is within the macro range. The release of an environmentally harmful oil mist, in which the droplet size of the lubricant is still smaller, is prevented. A disadvantage of the prior-art method, however, is that the lubricant is provided in atomized form with a relatively small drop size. The use for lubrication and cooling of the cutting tools is limited by the fact that the lubricant drops are fed to the lubrication point at relatively high speed.

DE 196 17 752 A1 discloses a method and a device for the lubrication of lubrication points with minimal quantities of lubricant, in which the lubricant is supplied to the lubrication point in the form of microdrops as a component of a liquid-gas mixture. The subject of this state of the art therefore is an atomizer, in which the lubricant is mixed with a gaseous carrier medium to form a lubricant mist that is supplied to the lubrication point. A disadvantage of the prior-art method or device is that the lubricant is released at the lubrication point in an especially small drop size—virtually as mist—, which is unfavorable with respect to environmental protection.

The object of the present invention is to provide a method and a device for the lubrication of lubrication points with minimal quantities of lubricant, so that permanent lubrication is possible in a simple manner, whereby the consumption of lubricant can be kept relatively low.

This object is achieved by the method of the invention, characterized in that the lubricant mist for the separation of lubricant drops is injected at high speed into an elongated chamber with distributed separation surfaces, which are perforated in the longitudinal direction of the chamber, so that the lubricant is moved through the chamber with continuous wetting of the separation surfaces in the direction of an outlet orifice and leaves the outlet orifice in the form of lubricant drops.

The advantage of the method of the invention is that an essentially total separation of the lubricant from the gaseous carrier medium can be achieved in a simple manner through the provision of perforated separation surfaces in the chamber. A point release of the lubricant drops occurs at the lubrication point, while the pressurized stream of the gaseous carrier medium can be utilized to keep away interfering dirt particles from the area of the lubrication point. The basic idea of the invention is to provide means that assure an almost total separation of lubricant, on the one hand, and the lubricant-transporting gaseous carrier medium, on the other. The lubricant separated from the gaseous carrier medium can be supplied to the desired lubrication points, whereby the lubricant drops are released at a predetermined time interval. Advantageously, the quantity of lubricant can be controlled or regulated through the design of the nozzle, so that the consumption of lubricant is relatively low. For example, the nozzle can be located on an open contact surface of a linear guide, so that the linear guide is constantly lubricated, whereby the droplet release interval is adjusted to the requirements of the linear guide. This results in a quasi-permanent lubrication, which, on the one hand, achieves an economical lubrication and, on the other, removal of interfering dirt particles.

According to an improvement of the method of the invention, the pressure of the lubricant mist can be controlled, so that the quantity of the released lubricant drops can be adjusted.

To achieve the device of the invention, the device of the invention is characterized in that an atomizer is connected via a feed line to a drop separation device located in the area of the lubrication point for the formation of lubricant drops, whereby, on the one hand, the lubricant drops and, on the other, essentially the gaseous carrier medium can be released at the lubrication point through an outlet orifice located downstream of the drop separation device.

The device of the invention advantageously has a drop separation device, in which an almost total separation of the lubricant from the gaseous carrier medium occurs. The basic idea of the invention is, on the one hand, to provide an atomizer, by means of which a lubricant mist including a mixture of a gaseous carrier medium and microdrops of the lubricant is formed, so that the lubricant can be transported in a simple manner via a feed line over long distances to the lubrication point. Through the provision of the drop separation device at the lubrication point, the lubricant is “filtered out” of the lubricant mist in a preset drop size and released directly at the lubrication point. Because of the almost total separation of the lubricant from the gaseous carrier medium, an effective lubrication and reliable removal of undesirable dirt particles can occur at the lubrication point. Because the gaseous carrier medium is largely free of lubricant particles, the release of the gaseous carrier medium is not environmentally harmful.

According to an improvement of the device of the invention, the separation surfaces are fashioned consistently and uniformly, so that a separation of the lubricant from the gaseous carrier medium can occur little by little in the direction of flow.

According to an improvement of the invention, the separation surfaces are formed by sphere packing, which includes a plurality of uniformly distributed spheres, which are movable relative to each other.

Attachment parts for a carriage, sliding on a guide rail, are known, which are flanged laterally to the carriage and have an inlet orifice, passage system, and an outlet orifice, so that lubricant drops can be supplied to the carriage for lubrication. The known attachment parts are not suitable for separating lubricant droplets from the lubricant mist supplied through the inlet orifice.

The object of the present invention therefore is to improve further an attachment part for a carriage, sliding on a guide rail of a machine component, such that separation of lubricant droplets from a lubricant mist is made possible.

To achieve this object, the invention is characterized in that a drop separation device is integrated such that it is possible to supply the inlet orifice with a lubricant mist, which is separated in the drop separation device into lubricant drops and a gaseous medium, whereby the lubricant drops and the gaseous medium are released together through the outlet orifice to the lubrication point.

Advantageously, the attachment part has a drop separation device, so that the lubricant is provided in the desired form and size directly at the lubrication point.

According to an improvement of the attachment part, an insert member is provided, which, on the one hand, has the function, by means of a nozzle disk provided with at least one nozzle passage, of achieving a narrowing of a cross section of a passage through which the lubricant mist can be passed. On the other hand, the size of the chamber, in which the separation surfaces are located and which is adjacent to the nozzle disk in the direction of flow, is established by the length of the insert member. A separation of the lubricant from the gaseous carrier medium occurs through the swirling of the lubricant mist on these separation surfaces.

According to an improvement of the invention, the attachment part of the invention has a sealing element between a body thereof and the carriage or an integrated reversal member, the sealing element is preferably flexible and achieves a pressure-tight sealing of the attachment part to the carriage, so that an undesirable escape of the lubricant mist is prevented.

Furthermore, it is an object of the invention to provide a lubrication point control device, so that a plurality of lubrication points, placed at a distance to one another, can be provided with lubricant in a simple manner.

To achieve this object, the lubrication point control device has the features of claim 19.

The advantage of the lubrication point control device of the invention is that an atomizer is provided to supply a plurality of lubrication points with lubricant. First, a separation of the lubricant from the lubricant mist, transportable in a simple manner over a longer distance, occurs directly at the lubrication points. Advantageously, a plurality of lubrication points can be controlled simply by appropriately allocated pressure regulators.

An exemplary embodiment of the invention will be explained in greater detail with reference to the drawings.

The figures show the following:

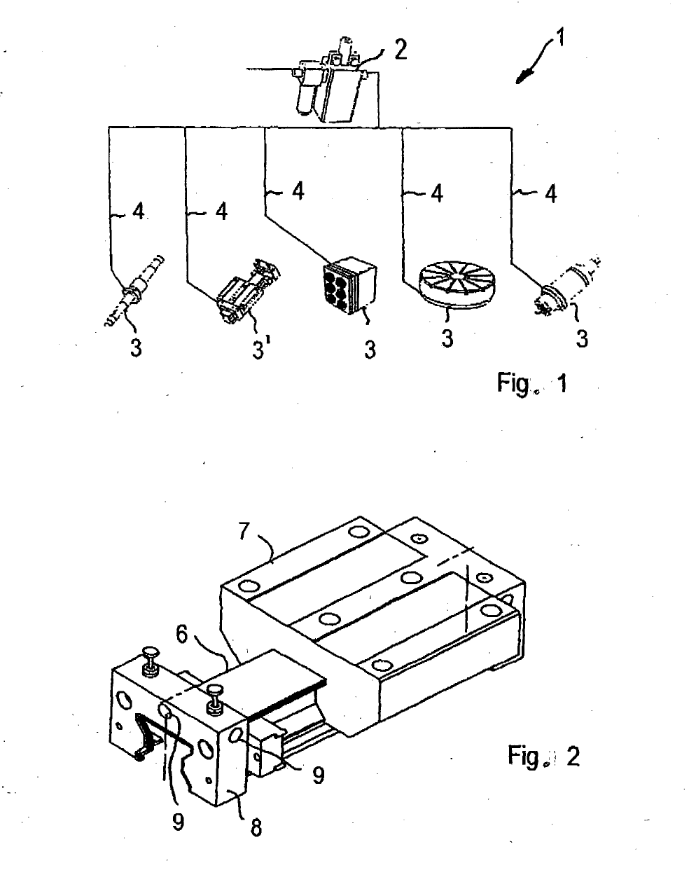

FIG. 1 a schematic view of a lubrication point control device, by which a plurality of lubrication points in machine components is provided with lubricant,

FIG. 2 a perspective view of a roller bearing guide with a carriage placed slidably on a guide rail and an attachment part to be flanged laterally to the carriage,

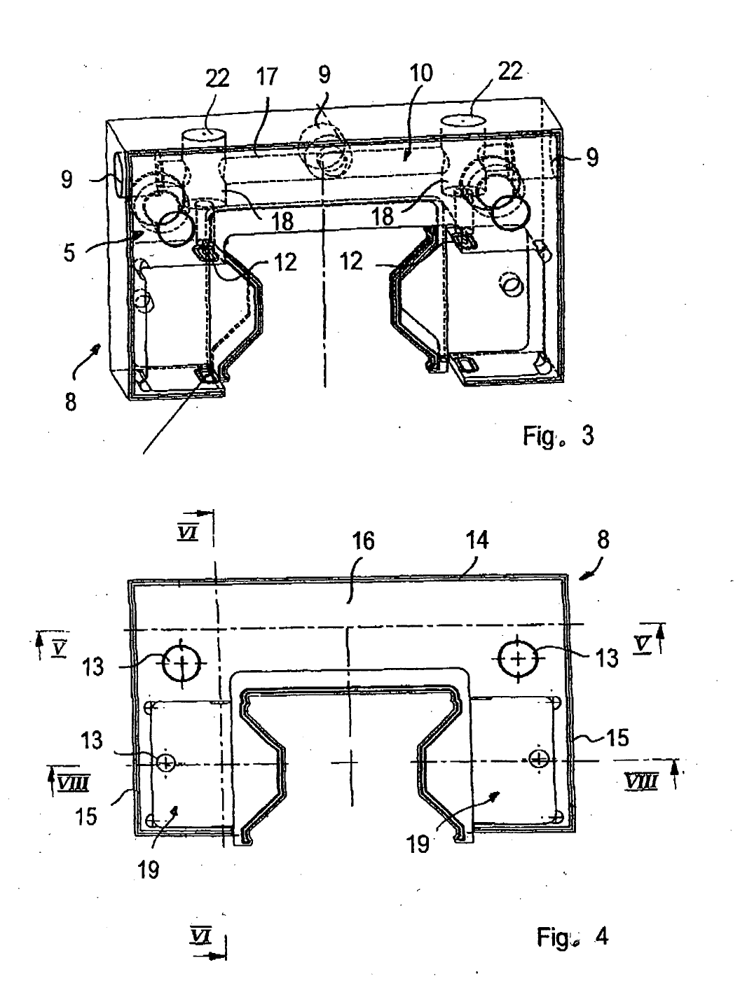

FIG. 3 a perspective view of the attachment part,

FIG. 4 an anterior view of the attachment part,

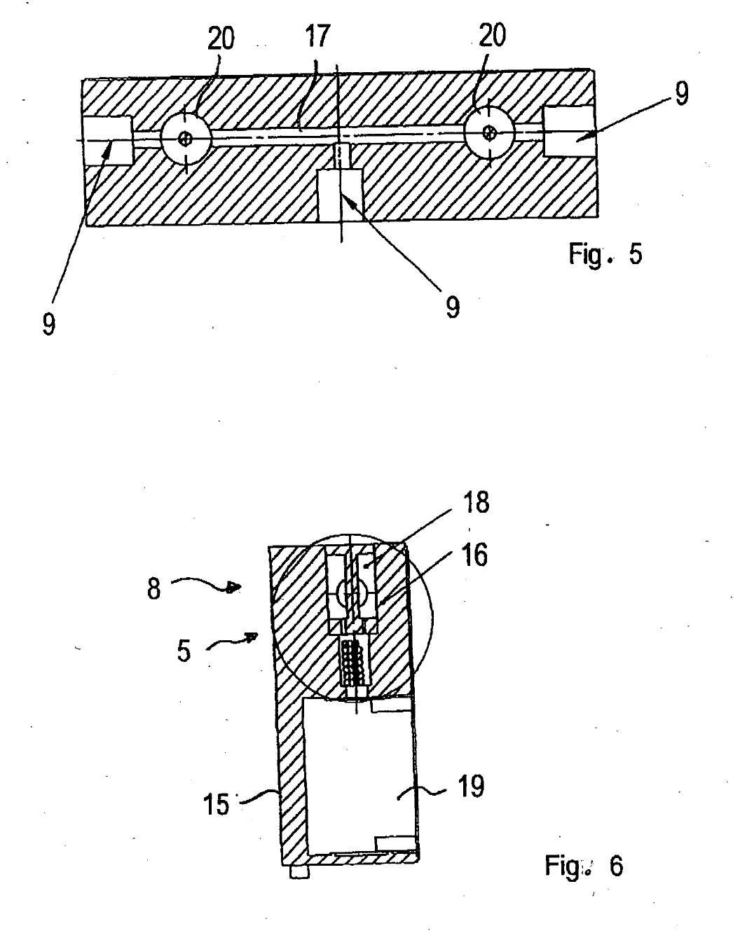

FIG. 5 a section through the attachment part along the line V-V of FIG. 4,

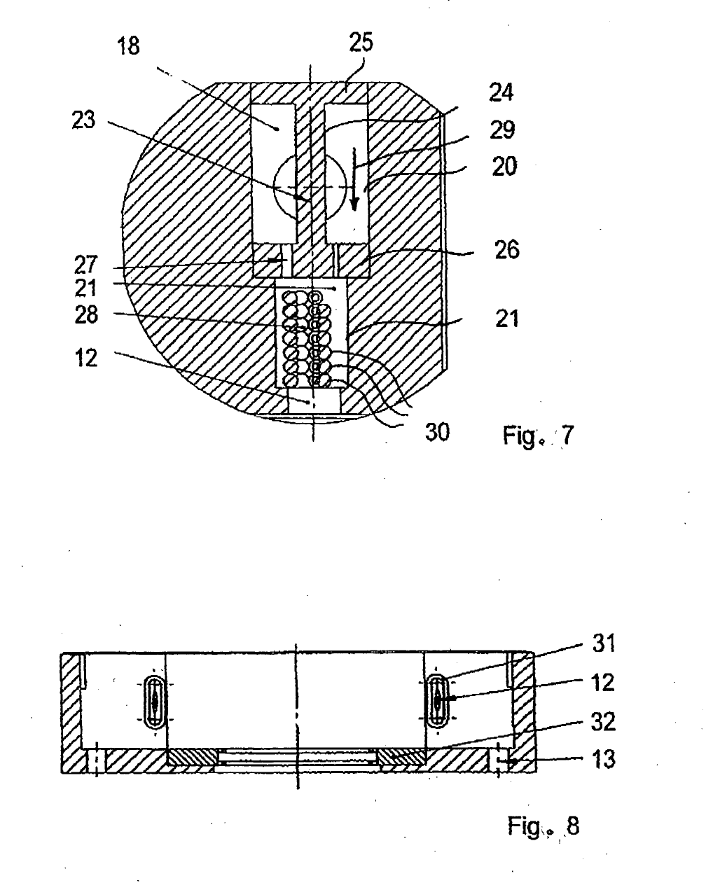

FIG. 6 a section through the attachment part along the line VI-VI of FIG. 4,

FIG. 7 an enlarged view of a portion of the attachment part of FIG. 6,

FIG. 8 a section through the attachment part along the line VIII-VIII of FIG. 4,

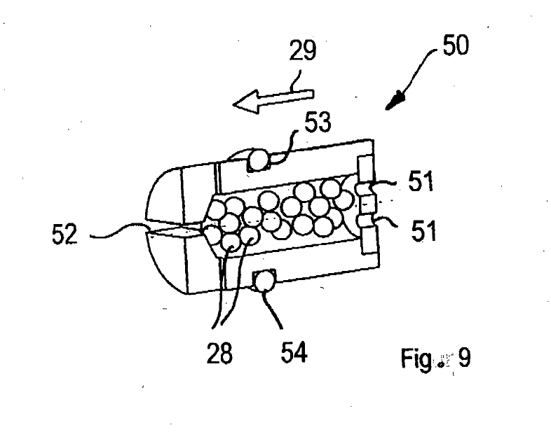

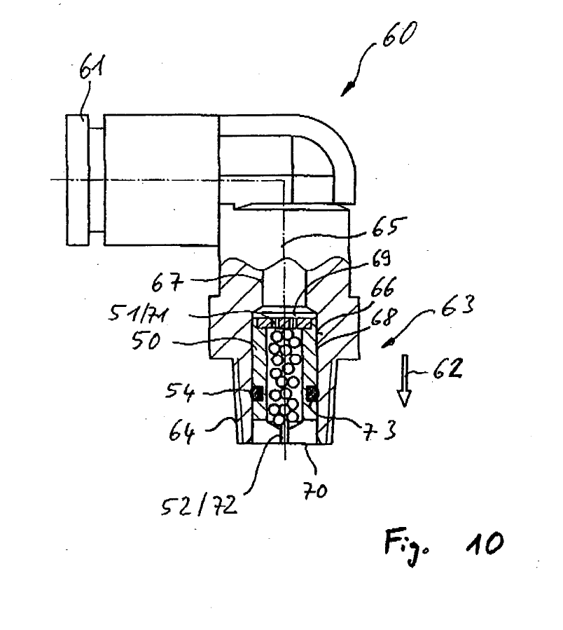

FIG. 9 a perspective view of a cut insert member according to an alternative embodiment, and

FIG. 10 a cross section through a connecting member.

FIG. 1 shows a lubrication point control device 1, which includes an atomizer 2, a plurality of lubrication points 3, 3′, and the atomizer 2 with feed lines connecting the individual lubrication points 3, 3′. The atomizer 2 is used to produce a lubricant mist, which is formed from a mixture of a gaseous carrier medium, preferably air, and microdrops of the lubricant. For this purpose, on the one hand, the lubricant and, on the other, the gaseous carrier medium are supplied to the atomizer 2. The atomization can occur according to the method described in publication DE 40 02 846 C2. The lubricant mist is supplied to the individual lubrication points 3, 3′ through the feed lines 4. A pressure valve, which is not shown, is allocated to the area of the atomizer 2 and/or to each individual lubrication points 3, 3′ to adjust the lubricant mist pressure.

Each lubrication point 3, 3′ is allocated a drop separation device 5, the function of which is described below by way of example for the lubrication point 3′, fashioned as a roller bearing guide. The feed lines can lead to different machine components, so that, for example, a ball screw assembly, a multi-spindle head, an indexing rotary table, or a work spindle can be placed at lubrication points 3 (see symbol in FIG. 1 arranged from left to right), with the exception of lubrication point 3′ placed at the roller bearing guide.

As can be seen more clearly in FIG. 2, the roller bearing guide includes a guide rail 6, on which a carriage 7 is slidably placed. An attachment part 8 is placed laterally on the guide rail 6; the purpose of the attachment part 8 is to provide the lubricant to the lubrication point 3′. For this purpose, the attachment part 8 has an inlet orifice 9, to which one end of the feed line 4 is connected to feed the lubricant mist into attachment part 8. Furthermore, attachment part 8 has a passage system 10, through which the lubricant mist is fed, in particular to the drop separation device 5. The drop separation device 5 achieves a separation of the lubricant from the gaseous carrier medium, so that the lubricant is released in the form of lubricant drops together with the carrier medium through at least one outlet orifice 12 to lubrication point 3. The outlet orifice is fashioned as a slit with a width of about 0.6 mm. Alternatively, the slit can also be fashioned as a plurality of boreholes distributed over the transverse surface.

The attachment part 8 has mounting holes 13, by means of which the attachment part 8 can be screwed onto the carriage 7. The attachment part 8 includes a plastic C-shaped body 14, which is fitted to the contour of guide rail 6, in particular on an inner side of the two legs 15. The legs 15 are connected with each other via a base part 16. The base part 16 has essentially the passage system 10, whereby, in accordance with the present embodiment, three inlet orifices 9 being provided. On the one hand, two opposing inlet orifices 9 are located on the end faces of the base part 16 and, on the other, on a long side, facing the carriage 7, of the base part 16. The passage feeds extend from the inlet orifices 9 to a passage 17, which extends essentially in the longitudinal direction of the base part 16 and from which in the area of the legs 15 a transverse lateral passage 18 runs in the direction of each of the legs 15. The lateral passages 18 lead to outlet orifices 12 allocated to each of the legs 15. The outlet orifices 12 abut a recess 19 in each of the legs 15, the recess being provided for the seating in each case of a reversal member, which is not shown. A branching and direct supplying of the lubricant drops to the roller bearing elements of the roller bearing guide 3′ is achieved through the reversal member.

The lateral passages 18 each have an upstream wide section 20 and a downstream narrow section 21. The wide section 20 of the lateral passage 18 is fashioned elongated beyond passage 17 to a side surface of the body 14, so that an insert member 23 can be inserted in the wide section 20 through a later sealable insertion opening 22. The insert member 23 has a spacer bolt 24, the diameter of which is smaller than the diameter of the lateral passage 18. Plunger-like disks 25, 26 are located at the opposite ends of the spacer bolt 24. The disk 25, which is located on a spacer bolt (24) side facing the narrow section 21 of lateral passage 18, is fashioned as a massive sealing disk and serves to close or block transverse passage 18 to the outside of the body 14. Escape of the lubricant mist is prevented in this manner.

The disk 26 facing the narrow section 21 of the lateral passage 18 is fashioned as a nozzle disk 26, and has one, two, or more through passages 27, which run coaxial to the lateral passage 18 and create a seal between the space, separated by nozzle disk 26, of the wide section 20 and the narrow section 21 forming a chamber. The nozzle disk 26 has a diameter corresponding to the diameter of the wide section 20, so that the lubricant mist can enter chamber 21 only through the through passages 27.

Before the insert member 23 is placed in the lateral passage 18, the narrow section 21 is filled with a plurality of movable spheres 28, which form a sphere packing. The chamber 21 is totally filled by the spheres 28, whereby the spheres 28 is formed of a series of concentrically arranged sphere rings 30 that run in the direction of the flow 29. The sphere rings 30 are located in a mutual transverse plane, the distance of the transverse planes of neighboring sphere series coinciding essentially with the diameter of the spheres 28. The diameter of the spheres is approximately 1 mm.

After the chamber 21 is filled with spheres 28, the insert member 23 is inserted in the lateral passage 18, whereby the narrowing of the lateral passage 18 at the transition between the wide section 20 and the narrow section 21 forms a stop for the nozzle disk 26. Subsequently, a tight locking of the insert member 23 in the lateral passage 18 is achieved at the sealing disk 25.

The through passages 27 are fashioned as transfer nozzles, the diameter of which is in a range of 0.5 mm to 0.8 mm. In the present exemplary embodiment, both transfer nozzles have a diameter of 0.7 mm.

The individual spheres 28 form separation surfaces, which are perforated in the direction of flow 29 and on which wetting by the lubricant particles occurs, which enter chamber 21 through the transfer nozzles 27 as a component of the lubricant mist.

The lubricant drops are provided at lubrication point 3′ according to the following method. The lubricant mist produced in atomizer 2 is fed through inlet orifices 9 into passage 17 under pressure. The lubricant mist can enter chamber 21 only through the transfer nozzles 27 of the insert member 23, whereby a Venturi effect occurs due to the reduction in the cross section. This initiates the separation process of the lubricant particles from the gaseous carrier medium (compressed air). The degree of separation of the lubricant is increased further in that the flow then enters and is passed through chamber 21 provided with the sphere packing, so that lubricant drops in the mm range can be provided at the outlet orifice 12. These lubricant drops are released together with the compressed air.

The separation process, taking place in chamber 21, results in a lubricant recovery of at least 98%. The passages 17, 18 are impinged upon by a dynamic pressure of the lubricant mist or of the compressed air flow of about 0.5 to 1.5 bar.

In the present exemplary embodiment, the reversal member placed in recess 19 redirects the rolling elements of the compressed air flow and the lubricant drops to the different lubrication subpoints of the roller bearing guide. For this purpose, a circumferential sealing element 31 is provided at the outlet orifice 12 or in an outlet area of the reversal member.

As can be seen especially from FIG. 8, a sealing element 32 is placed between the body 14 and the guide rail 6, which together with sealing elements (not shown further) leads to a hermetic pressure-proof blocking of the air and oil.

According to an alternative embodiment, the sealing elements 31, 32 can also be injection molded onto an inside wall of the body 14.

According to an alternative embodiment, the insert member 23 can also be designed for plugging in, whereby it already contains the sphere packing. The dimension of the insert member can be fitted to the dimension of the wide chamber 20 and/or the narrow chamber 21.

The mounting can be greatly simplified through the design of an insert member fashioned as a hollow cylinder. For example, one or several boreholes, through which the air and oil are released to the lubrication point, can be distributed over the surface on the end face, situated in front and in the direction of flow, of insert member 23.

According to a preferred embodiment of insert member 23 in accordance with FIG. 9, the insert member 23 is fashioned as a lubricant cartridge 50, which is inserted into chamber 21. The lubricant cartridge 50 is fashioned as a hollow cylinder, whereby it has at an end face, situated behind in the direction of flow, two circular through passages 51 for the entry of the lubricant mist. Alternatively, the insert member 23 can also have one or more entry passages/through passages 51. The diameter of both through passages 51 is adjusted to the size of the spheres 28 packed within the lubricant cartridge 50, so that no sphere 28 can leave the interior of the hollow cylinder. The diameter of the through passages 51 can be in a range of 0.5 to 0.8 mm and is therefore smaller than the diameter of the spheres 28. The outlet situated in front in the direction of flow 29 is fashioned as a cross-slit outlet 52, whereby the width of the slit is smaller than the diameter of the spheres 28. The width of the X-shaped or perpendicular to one another slits, which meet at a midpoint, can be in a range of 0.4 to 0.65 mm. Advantageously, the slit extends over the entire width of the lubricant cartridge 50 shaped as a hollow cylinder, whereby the main outlet area is disposed in the center on the longitudinal axis of the lubricant cartridge 50. The total outlet area of this cross-shaped slit is greater than the total inlet area of the through passages 51. A too high flow stagnation is avoided thereby, which would lead to undesirable atomization of the lubricant drops already separated from the compressed air in this area. It is preferable that the length of the slit is greater than twice the diameter of the spheres 28, so that extensive blocking of outlet 52 by the spheres 28 is prevented.

For simplified mounting of the lubricant cartridge 50, the lubricant cartridge 50 has a circumferential groove 53, in which an O-ring 54 is located, so that the O-ring 54 projects somewhat from the cylindrical surface of the lubricant cartridge 50. A tight seating of the lubricant cartridge 50 in chamber 21 can be assured thereby in a simple manner. The diameter of the lubricant cartridge 50 is to be adjusted to the inside diameter of chamber 21, so that the lubricant cartridge 50 is located with an accurate fit in the chamber 21, in particular by a press fit. The lubricant cartridge 50 is held securely in chamber 21 due to the fact that the insert member 23 adjoins in the wide section 20.

FIG. 10 shows a connecting member 60, which is used for the separable connecting of the above-described feed line 4, which transports the lubricant mist, with a housing at the lubrication point 3, 3′. In contrast to the above described attachment part, the connecting member 60 is flexible and versatile in use, because it can be connected via a first connection 61 with commercial pneumatic or hydraulic feed lines 4. The first connection 61 is preferably fashioned as a commercial plug-type connection, which is connected to a pneumatic feed line 4.

Alternatively, the connection 61 can also be fashioned as a screw connection, which can be connected to a hydraulic feed line 4.

A second connection 63 is located as a screw connection on a side, situated in front in the direction of the flow arrow 62, of the connecting member 60 to connect the connecting member 60 with a housing (not shown) of the lubrication point 3, 3′. The second connection 63 has a male thread 64, by which the connecting member 60 can be connected with a friction type connection with a female thread (not shown) of the housing. The axis of symmetry 65 of the second connection 63 or male thread 64 is preferably oriented in a radial direction to the hollow-cylindrical housing of the lubrication point. The housing, for example, can be fashioned as a part of a ball screw assembly, a work spindle, an index rotary table, roller bearing guides, multi-spindle heads, or the like. In this case, the male thread 64 has a depth such that the free end of the second connection 63 directly reaches the lubrication point 3, 3′.

In the present embodiment, according to FIG. 10, the connecting member 60 is fashioned as an angle. Alternatively, the connecting member 60 can also be fashioned straight or oblique.

The connecting member 60, in the area of the second connection 63, has a hollow space 66 for receiving an insert member 50 or a lubricant cartridge 50. The hollow space 66 is widened, in comparison with passage 67 that is provided through the remaining area of the connecting member 60, in order to convey the lubricant mist.

The insert member 50 essentially forms the drop separation device 5. For this purpose, the insert member 50 has a hollow-cylindrical chamber 21, in which a plurality of perforated separation surfaces 28 is located. The insert member 50 in FIG. 10 corresponds to the insert member in FIG. 9 and has an essentially circular cylindrical surface 68, which are bordered at an end side, on the one hand, by a face surface 69 that is perpendicular to the direction of flow 62 and behind in the direction of flow 62 and, on the other, by an outlet area 70 disposed perpendicular to the direction of flow 62 and ahead in the direction of flow 62. The face surface 69 has two through openings 71, through which the lubricant mist enters chamber 21. The outlet area 70 has two outlet slits 72 arranged as a cross, each of which run continuously and straight between opposing areas of the cylindrical surface 68. The stretch, running in the direction of flow 22, of the outlet slits 72 is at least as long as the length of the through opening 51, preferably longer.

The outlet slits 72 are cut into the cylindrical surface 68 by this preset depth. The outlet area 70 in the mounted position is preferably flush with the free end of the second connection 62. The width of the outlet slit 72 can correspond to the diameter of the through openings 71, for example, 0.5 mm. The length of the insert member 50 can be, for example, 12 mm.

To mount the insert member 50 in the hollow space allocated to the second connection 63 of the connecting member 60, the insert member 50 has an O-ring 54, which is set in an exterior annular groove 73 of the cylindrical surface 68. The insert member 50 is connected with a positive fit, securely, and tightly with the connecting member 60 after the pressing insertion into the hollow space of the connecting member 60.

Advantageously, therefore, the insert member 50 can be integrated into a connecting member 60, so that the connecting member has a compact structure. It has a dual function. On the one hand, it serves to connect the feed line 4 of the lubricant with a housing of the lubrication point. On the other, the transformation of the lubricant mist into the lubricant drops necessary for the lubrication occurs in connecting member 60.

Alternatively, the insert member 50 can be provided independent of the connecting member 60 directly in a housing at the lubrication point 3, 3′. It is essential that the insert member 50 is integrated in the housing in such a way that the outlet area 70 is located directly at the lubrication point 3, 3′.

1. Method for the lubrication of lubrication points with minimal quantities of lubricant, in which the lubricant is mixed with a gaseous carrier medium to form a lubricant mist and in which the lubricant mist is supplied to the lubrication point, characterized in that the lubricant mist for the separation of lubricant drops is injected under pressure into an elongated chamber (21) with distributed separation surfaces (28), which are perforated in the longitudinal direction of the chamber (21), so that the lubricant is moved with continuous wetting of the separation surfaces (28) through the chamber in the direction of an outlet orifice (12) and leaves the outlet orifice (12) in the form of lubricant drops.

2. Method according to claim 1, characterized in that the lubricant mist is injected continuously into the chamber (21) provided with separation surfaces (28).

3. Method according to claim 1 or 2, characterized in that the pressure of the lubricant mist is controlled.

4. Device for the lubrication of lubrication points with minimal quantities of lubricant with an atomizer to produce a lubricant mist, which is formed from a mixture of gaseous carrier medium and microdrops of the lubricant, characterized in that the atomizer is connected via a feed line (4) with a drop separation device (5), located in the area of the lubrication point (3, 3′), for the formation of lubricant drops, whereby, on the one hand, the lubricant drops and, on the other, essentially the gaseous carrier medium can be released at the lubrication point (3, 3′) through an outlet orifice (12) located downstream of the drop separation device (5).

5. Device according to claim 4, characterized in that the drop separation device (5) has a chamber (21) with separation surfaces (28), perforated in the direction of flow (29), to which the lubricant particles, injected through a through passage (27), of the lubricant mist adhere, and that the separation surfaces (28) are disposed in the direction of flow (29) directly one after another up to an end, allocated to the outlet orifice (12), of the chamber (21), so that the lubricant drops are released at the outlet orifice (12).

6. Device according to claim 4 or 5, characterized in that the separation surfaces (28) extend evenly and uniformly in the direction of flow (29) within the chamber (21).

7. Device according to any one of claims 4 through 6, characterized in that the separation surfaces are formed by a plurality of spheres (25), which are combined into a sphere packing and totally fill the interior of the chamber (21).

8. Device according to any one of claims 4 through 7, characterized in that the sphere packing is formed by a series, running in the direction of flow, of concentrically arranged sphere rings (30), whereby the spheres (28) of the sphere rings (30) are located in a common transverse plane.

9. Device according to any one of claims 4 through 8, characterized in that the through passage (27) is fashioned as at least one transfer nozzle, whereby the diameter of the transfer nozzle is in a range of 0.5 mm to 0.8 mm.

10. Device according to any one of claims 4 through 9, characterized in that the through passage (27) is formed by one or more transfer nozzles arranged around the central axis of the chamber (21).

11. Device according to any one of claims 4 through 10, characterized in that the outlet orifice (12) is fashioned as a slit, the length of which is greater than the twice the diameter of the spheres (25).

12. Device according to any one of claims 4 through 11, characterized in that the total area of the outlet orifice (12) is greater than the total area of the through passages (27) forming the inlet.

13. Device according to any one of claims 4 through 12, characterized in that the slit (12) is fashioned in the shape of a cross, whereby the juncture of the slits lies on the longitudinal axis of the chamber (21).

14. Attachment part for a carriage, sliding on a guide rail of a bearing guide, with at least one inlet opening for supplying a lubricant, with at least one outlet orifice for releasing the lubricant to the reversal of the carriage, with a passage system including at least one passage for conveying the lubricant between the inlet orifice and the outlet orifice, characterized in that a drop separation device (5) is integrated such that it is possible to supply the inlet orifice (9) with a lubricant mist, which is separated in the drop separation device (5) into lubricant drops and a gaseous medium, whereby the lubricant drops and the gaseous medium are released together through the outlet orifice (12) to the lubrication point (3, 3′).

15. Attachment part according to claim 14, characterized in that an insert member (23) can be inserted into a passage (18), whereby the insert member (23) has at least one through passage (27), and that the through passage (27) is followed by a chamber (21) containing a plurality of separation surfaces (28).

16. Attachment part according to claim 14 or 15, characterized in that the insert member (23) can be inserted and fixed with an accurate fit in the passage (18) and/or in the chamber (20, 21).

17. Attachment part according to any one of claims 14 to 16, characterized in that the insert member has a spacer bolt (24), the diameter of which is smaller than the diameter of the passage (18), and that a nozzle disk (26) containing the through passage adjoins on a side, facing the chamber (21), of the spacing bolt (24), and the diameter of the disk corresponds to the diameter of the passage (18).

18. Attachment part according to any one of claims 14 through 17, characterized in that a sealing element (31, 32), which prevents the discharge of the pressurized gaseous medium, is located between a body (14) of the attachment part (8) and the carriage (7) and/or the body (14) and a reversal member insertable in the body (14), for reversal of the rolling elements to the individual lubrication points and/or the body (14) and the guide rail (6).

19. Use of the attachment part as a connecting member between the feed line (4) and a housing of the lubrication point (3, 3′), whereby an insert member (50) with a plurality of integrated separation surfaces (28) is pressed into the attachment part.

20. Connecting member for separable connection of a feed line (4), transporting the lubricant mist, with a housing of the lubrication point (3, 3′), especially in a device according to any one of claims 4 through 13 or in an attachment part according to any one of claims 14 through 16,
with a first connection (61) for the separable connection with an end of the feed line (4),
with a second connection (63) for the separable connection with the housing of the lubrication point (3, 3′), and
with a integrated drop separation device (5).

21. Connecting member according to claim 20, characterized in that the drop separation device (5) is formed by an insert member (50) with a plurality of perforated separation surfaces (28), which is provide form-fittingly in a hollow space (66) of the connecting member (60).

22. Connecting member according to claim 20 or 21, characterized in that the hollow space (66) is located within the area of the second connection (63), facing the housing, that the hollow space (66) has a cylindrical form with a side open to the lubrication point (3, 3′), and that the insert member (50) is pressed into the hollow space (66).

23. Connecting member according to any one of claims 20 through 22, characterized in that the insert member (50) is sealed by means of an O-ring (54) in the hollow space (66).

24. Connecting member according to any one of claims 20 through 23, characterized in that the first connection (61) is fashioned as a plug-type connection for connecting to a pneumatic feed line (4) or as a screw connection for connecting to a hydraulic feed line (4).

25. Connecting member according to any one of claims 20 through 24, characterized in that the second connection (63) is fashioned as a screw connection with a male thread (64) and has a hollow space for accepting the insert member (50).

26. Insert member for placement in the area of lubrication points (3, 3′), in particular in a device according to any one of claims 4 through 13, or in an attachment part according to any one of claims 14 through 16, or in a connecting member according to any one of claims 20 through 25,
with a hollow-cylindrical chamber (21), in which a plurality of perforated separation surfaces (28) is provided,
with an essentially circular cylindrical surface (68),
with an end face (69) placed perpendicular to the direction of flow (62) and behind in the direction of flow (62) and containing at least one through opening (51), and
with an outlet area (52) arranged perpendicular to the direction of flow (62) and in front in the direction of flow (62) and containing at least one outlet slit (72).

27. Insert member according to claim 26, characterized in that the outlet slit (72) extends at least from inside to an area of the cylindrical surface (68) and is cut into the cylindrical surface (68) against the direction of flow (62).

28. Insert member according to claim 26 or 27, characterized in that the cylindrical surface (68) has an exterior annular groove (73) for accepting an O-ring (54).

29. Lubrication point control device containing a central atomizer (2) to produce a lubricant mist, which is formed from a mixture of gaseous carrier medium and microdrops of the lubricant, a plurality of lubrication points (3, 3′) located remotely via feed lines (4) from the atomizer (2), which are each coupled parallel to one another at the atomizer (2).

30. Lubrication point control device according to claim 29, characterized in that the lubrication points (3, 3′) are each connected via a feed line (4) with the atomizer (2) and that the feed line (4) is allocated a pressure regulator for the lubrication point-dependent setting of the pressure of the lubricant mist.
